(19) United States
(12) Patent Application Publication
(10) Pub. No.: US 2025/0251521 A1
(43) Pub. Date: Aug. 7, 2025

(54) SYSTEM AND METHOD FOR GENERATING MODELED DATA BASED ON WAVEFIELD PROPAGATION WITH TIME-VARIANT SUBSURFACE PROPERTY

(71) Applicant: CGG SERVICES SAS, Massy Cedex (FR)

(72) Inventors: Andrew RATCLIFFE, Henfield (GB); James COOPER, Redhill (GB); Gordon POOLE, East Grinstead (GB)

(21) Appl. No.: 19/022,240

(22) Filed: Jan. 15, 2025

Related U.S. Application Data
(60) Provisional application No. 63/627,842, filed on Feb. 1, 2024.

(51) Int. Cl. G01V 1/30; G01V 1/38

(52) U.S. Cl. CPC G01V 1/306; G01V 1/307; G01V 1/38

(57) ABSTRACT

A method for generating an image (I_{F}) of a subsurface includes receiving an initial earth model of the subsurface, receiving a recorded dataset d associated with the subsurface, generating a modeled dataset p based on the initial earth model and recording positions corresponding to the recorded dataset d, wherein the modeled dataset p is calculated based on a parameter volume PV that varies in time, updating the initial earth model, to generate an updated earth model, based on a misfit function that depends on the recorded dataset d and the modeled dataset p, and generating the image I_{F} of the subsurface based on the updated earth model.

### BACKGROUND OF THE INVENTION

### Technical Field

Embodiments of the subject matter disclosed herein generally relate to seismic data processing methods and systems that employ wavefield propagation with time-variant subsurface property for obtaining accurate images of explored underground formations.

### Discussion of the Background

Seismic surveys save companies from the significant expense of drilling unsuccessful offshore wells, expenses that are only magnified when the unprofitable well is drilled under several thousand feet of water. Underground formation images generated by processing data acquired during seismic surveys provide information about the underground formation's features (porosity, density, etc.), and even precisely whether and where subsurface resources (e.g., hydrocarbons, mineral deposits, geothermal resources, etc.) are present therein.

Hydrocarbon exploration and development uses waves (e.g., seismic waves or electromagnetic waves) to explore the structure of underground formations on land and/or at sea (i.e., formations under the seafloor). As schematically illustrated in FIG. 1, a marine seismic survey system 100 includes a seismic source 110 towed by a vessel 102, and one or more sensors 130. Sensors 130 may be distributed along a streamer (not shown) or placed on the ocean bottom as ocean bottom nodes. For this configuration, waves 112 emitted by the source 110, at a known location, penetrate an explored formation 121-127 and are reflected, refracted or diffracted at interfaces 120, 122, 124, and 126, which separate the formation's layers having different layer properties. The sensors 130 detect the returning waves 140, 150. Note that, as used herein, the term “subsurface” refers to any geophysical structure into which the source energy is injected to perform seismic surveying, e.g., land, ocean bottom, transition zone or marine based. The term “formation” refers to a specific structure in the subsurface, for example, a fault line.

In order to image the structure of the explored underground formations, various procedures/steps are performed on the seismic data recorded by sensors 130. One of those procedures is Full Waveform Inversion (FWI). FWI is used for deriving high-resolution models of subsurface (Earth) parameters from seismic data recordings. These earth parameters can include, for example, pressure-wave and shear-wave velocity (Vp and Vs), attenuation (viscosity), density, impedance, reflectivity and anisotropy, among others, and are referred to here using the general terms “velocity model” or “earth model” or “model.” Having such a model allows the geophysicist to generate synthetic or modeled data, which can then be compared to the actual recorded data for improving the model.

FWI is a nonlinear inversion scheme with the objective of determining subsurface properties which minimize the misfit between the observed seismic data (also described in this document interchangeably as real or field data) and the synthetic data obtained from a candidate model, which is an earth model or a model of the earth's parameters. These earth models may be calculated using, for example, travel time tomography on the seismic data, as described in [1], a previous implementation of FWI on the seismic data, or well log information. The misfit is commonly defined by an objective function that measures the least-squares data difference between the observed and modeled data, as discussed, for example, in [2]. Other misfit functions may be used in full waveform inversion, for example, an optimal transport [3], an adaptive waveform [4], a dynamic warping [5], a partial matching [6], or a time-lag [7] misfit function. The term “modeled data” refers in this document to the synthetic data obtained by propagating a source wavefield through an earth model according to some wave equation, then extracting the wavefield at one or more receiver locations.

However, the existing methods are not capable of accurately calculating the modeled data. Thus, there is a need for a new method and associated system that are capable of generating improved modeled data, which results in a more accurate image of the subsurface formations.

### SUMMARY OF THE INVENTION

According to an embodiment, there is a method for generating an image (I_{F}) of a subsurface, and the method includes receiving an initial earth model of the subsurface, receiving a recorded dataset d associated with the subsurface, generating a modeled dataset p based on the initial earth model and recording positions corresponding to the recorded dataset d, wherein the modeled dataset p is calculated based on a parameter volume PV that varies in time, updating the initial earth model, to generate an updated earth model, based on a misfit function that depends on the recorded dataset d and the modeled dataset p, and generating the image I_{F} of the subsurface based on the updated earth model.

According to another embodiment, there is a method for generating a modeled dataset p associated with a subsurface of the Earth, and the method includes receiving a first wavefield P₁, receiving a first parameter volume PV1, where the first parameter volume PV describes an earth property as a function of a subsurface space, and calculating a second wavefield P₂, after the first wavefield P₁ reflects or refracts at a reflector R in the subsurface, based on a propagation of the first wavefield P₁ through the first parameter volume PV1. The first parameter volume PV1 varies, after calculating the second wavefield P₂, for a same point in the subsurface space.

According to yet another embodiment, there is a computing system for generating an image (I_{F}) of a subsurface, and the computing system includes an interface configured to receive an initial earth model of the subsurface and also to receive a recorded dataset d associated with the subsurface and a processor in communication with the interface. The processor is configured to generate a modeled dataset p based on the initial earth model and the recorded dataset d, wherein the modeled dataset p is calculated based on a parameter volume PV that varies in time, update the initial earth model, to generate an updated earth model, based on a misfit function that depends on a difference between the recorded dataset d and the modeled dataset p, and generate the image I_{F} of the subsurface based on the updated earth model.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a marine seismic acquisition system;

FIG. 2 is a flow chart of a method for calculating an image of a subsurface based on full waveform inversion method in which a parameter of the earth is a function of time;

FIG. 3 is a flow chart of a method for propagating a wavefield to a desired position based on the parameter that is a function of time;

FIGS. 4A to 4C show a traditional propagation of a wavefield through the surface at three different times;

FIGS. 5A and 5B schematically illustrate a possible dependency of the parameter with time;

FIG. 6 is a flow chart of a method for calculating amplitude versus angle (AVA) information based on the parameter that is a function of time;

FIG. 7 schematically illustrates measured data where the reflection coefficient is independent of a reflection angle (commonly termed a ‘flat’ AVA response);

FIG. 8 schematically illustrates measured data that has an AVA response that varies with a reflection angle;

FIG. 9A illustrates angle gathers used by a traditional FWI method, FIG. 9B illustrates the observed data, FIG. 9C illustrates the modeled data obtained with the traditional FWI method, and FIG. 9D illustrates the residual between the observed data and the modeled data;

FIGS. 10A to 10C show a modified propagation of a wavefield through the surface at three different times;

FIG. 11 schematically illustrates the calculation of a parameter value at a position in the subsurface;

FIG. 12A illustrates angle gathers used by the methods discussed herein, FIG. 12B illustrates the observed data, FIG. 12C illustrates the modeled data obtained with the method of FIG. 3, and FIG. 12D illustrates the residual between the observed data and the modeled data; and

FIG. 13 is a schematic diagram of a computing system that implements one or more of the methods discussed herein.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to seismic data acquired in a marine environment. However, the embodiments to be discussed next are not limited to a marine environment, but may be applied to other environments.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

With conventional seismic data processing, pre-stack migrated data are often used in analyses of AVA or amplitude-versus-offset (AVO) effects of reflection data, which can be indicators of hydrocarbons in the subsurface, where the estimated AVO parameters may relate to an amplitude intercept and an amplitude gradient with offset or angle. In general, wave propagation in the real Earth is described most accurately by the elastic (or visco-elastic) wave equation. However, the use of elastic wave propagators is known to be an expensive process, and more expensive than the use of acoustic wave propagators. However, traditional FWI approaches (as discussed above) are based only on acoustic, or visco-acoustic, wave-propagation and often do not represent this amplitude behavior accurately enough to be used as a hydrocarbon indicator. A number of alternative solutions to this problem are briefly discussed after illustrating the FWI method.

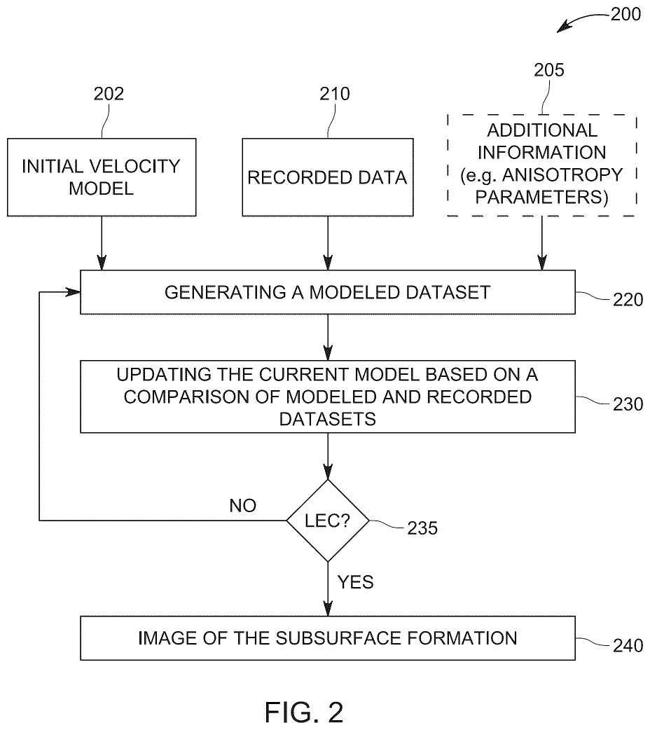

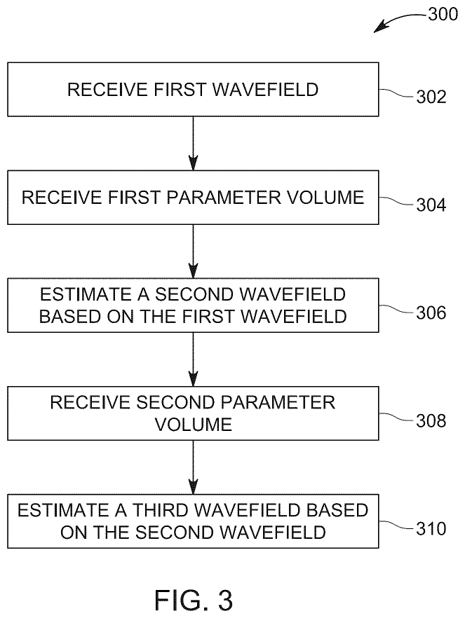

The FWI method is an iterative approach requiring an a priori initial model, which is then repeatedly updated via an inversion algorithm. In an ideal case, the updated model converges to the true model representing the observed data. An exemplary flow of an FWI process 200 is presented in FIG. 2. The method 200 starts by receiving in step 202 an initial velocity model, as discussed above. The method also receives in step 210 the recorded data d and in optional step 205 additional information, for example, anisotropy parameters. The FWI method then iteratively performs step 220 of generating a synthetic dataset (modeled data p) and step 230 of updating the current model until a loop-exiting criterion, LEC, is met in step 235. Note that the step 220 of generating the modeled dataset p may be based on the initial velocity model and the receiver locations identified by the recorded dataset d, where the modeled dataset p is calculated based on a parameter volume, PV, that varies in time, as discussed later with regard to FIG. 3.

The LEC may be related to a model's convergence or simply a predetermined number of iterations. In the case of complex models with multiple non-independent parameters, different subsets of the parameter values may be updated at different iterations. When the LEC is met, the subsurface formation is imaged in step 240 based on the latest (updated) velocity model and the wavefields obtained in step 230. Thus, a final image I_{F} of the subsurface is obtained.

The nonlinear inversion problem mentioned above connects a candidate earth model V and a wavefield P via a nonlinear forward operator G, as described in equation (1):

$$G ( V ) = P . \qquad ( 1 )$$

The operator G describes how to generate a wavefield P corresponding to a given model V. As such, it represents the propagation of a seismic source or sources as a function of time through a medium described by V and according to a known wave equation. This wavefield P is linked to the modeled dataset p by an extraction operator, namely the extraction of the wavefield only at the spatial locations of the receivers for each time sample. In this regard, note that the wavefield P exists at all locations in space, for each time step, while the dataset p represents a measurement (extraction) of this wavefield at the spatial locations of the receivers. To distinguish between a wavefield and a corresponding dataset, the wavefields are represented by capital letter and the datasets by lower case. If M represents the true Earth model, and D the observed wavefield (linked to the known real data or the measured data d by the extraction operator), then the following relationship holds:

$$G ( M ) = D . \qquad ( 2 )$$

The inversion scheme aims to find a model which minimizes the misfit between the modeled data p and the observed data d, typically in a least-squares sense. Iterative gradient-based inversion algorithms such as Steepest Descent, Conjugate Gradient, or Limited-memory Broyden-Fletcher-Goldfarb-Shanno (LBFGS) may be used to solve the inversion problem. However, alternate inversion schemes exist.

FWI may come in many flavors. For example, a traditional FWI method is the acoustic FWI method. An alternative to the acoustic FWI method is elastic FWI. For this case, the method inverts for, or honors an existing, elastic, shear-wave, velocity, as well as the acoustic, pressure-wave, velocity. The presence of non-zero shear-wave velocity results in more accurate amplitudes in the data modeled during the inversion, thus leading to a more accurate amplitude variation with reflection angle of the modeled data. These improvements lead to an inverted earth model that more accurately describes the real Earth. While in theory this approach is appealing, elastic FWI is very expensive to run for high frequencies and also the multi-parameter nature of the approach may result in leakage between the inverted Vp and Vs models.

Another approach is using an augmented acoustic wave equation, as proposed by the authors in McLeman et al. (McLeman, J., Burgess, T., Sinha, M., Hampson, G. and Thompson, T., [2021] Reflection FWI with an augmented wave equation and quasi-Newton adaptive gradient scheme. First International Meeting for Applied Geoscience & Energy, Expanded Abstracts, 667-671) and in Burgess et al. (WO patent application No. 2021/252693). This approach adds terms to the conventional acoustic wave equation in an attempt to mimic elastic amplitude behavior. The authors of this work claim that these modifications allow AVA information to be derived directly as an output of the acoustic FWI process. The physical justification for this approach is not completely clear and, for example, one can no longer derive this augmented acoustic wave from the more general elastic wave equation which governs the wave propagation in the Earth.

Applications of acoustic FWI at different reflection angles was proposed by Yang et al. (U.S. Pat. No. 10,520,619) and Warner et al. (Warner, M., J. Armitage, A. Umpleby, N. Shah, H. Debens, F. Mancini [2022] AVO determination using acoustic FWI. 83rd EAGE Conference & Exhibition, Extended Abstracts, p 1-5). This approach involves running acoustic FWI for input data, muted to different reflection angles, or offsets. The FWI approaches may include velocity and/or density inversions, where each inversion only needs to satisfy the input data within a given angle, or offset, range. The models may be subsequently corrected from its zero-angle amplitude following Yang et al. or Warner et al. Angle-dependent wavelet corrections may be made following Yang et al. One issue in these approaches is that there is a need to convert from the surface offset acquisition domain into the subsurface reflection angle domain. In a simple 1D earth model, this conversion can be easily done using a straight-ray approximation and Snell-Dix ray bending. For earth models with moderate 3D complexity, ray-tracing can be performed. However, in complex 3D models, even ray-tracing can become inaccurate. There also exists further complications on whether this conversion from offset to angle is done on the data before or after the FWI process.

Alternatively, it is possible to perform simultaneous inversion of velocity and angle-dependent reflectivity as proposed by Chemingui et al. (Chemingui, N., Yang, Y., Ramos-Martinez, J., Huang, G., Whitmore, D., Crawley, S., Klochikhina, E., and Arasanipalai, S. [2023] Simultaneous inversion of velocity and angle-dependent reflectivity. IMAGE conference proceedings) and Yang et al. (Chemingui, N., Yang, Y., Ramos-Martinez, J., Huang, G., Whitmore, D., Crawley, S., Klochikhina, E., and Arasanipalai, S. [2023] Simultaneous inversion of velocity and angle-dependent reflectivity. IMAGE conference proceedings). This approach describes a form of FWI using an acoustic wave equation parameterized by velocity and vector reflectivity. The authors claim that, by incorporating an angle dependence into the vector reflectivity parameter, the AVA information can be extracted directly from the inversion output, in the form of reflection angle gathers. These angle gathers may subsequently be used for conventional AVA analysis, for example, the determination of an AVA intercept and gradient. A component of this method is the estimation of a wavefield reflection angle, achieved by considering a combination of the vector reflectivity of a subsurface and a wavefield propagating in the subsurface. One difficulty with this method is that the accuracy of the reflection angle estimate may be affected by the complexity of both the reflectivity and the wavefield, particularly near interfaces in the subsurface, where this complexity may be increased due to abrupt changes in subsurface parameters. A further complication with this method is that the simultaneous inversion of velocity and angle-dependent reflectivity typically inverts a smooth velocity model only, whereas in the real Earth the velocity model is not smooth.

In view of the limitations of the above discussed methods, the inventors have found that propagating a wavefield in the subsurface using a propagator (elastic, acoustic, or elasto-acoustic) while making one or more subsurface parameters vary as a function of travel-time (which may be related to a source wavefield propagation direction), improve the quality of the image generated based on any of the FWI methods that use an objective function. Note that the propagation of the wavefield though a parameter volume that changes as a function of the travel-time may be applied to various existing methods (for example, those discussed above). The parameter volume refers to one or more parameters describing a given volume of the subsurface, and the FWI method iteratively propagates the wavefields through the given volume. The resulting wavefield may be used to simulate modeled data, which may be compared with the recorded data to estimate a misfit function. An Earth model may then be modified to minimize the misfit-function. In other words, the FWI method 200 illustrated in FIG. 2 may use the wavefield propagation discussed next in one of the steps 220 and/or 230.

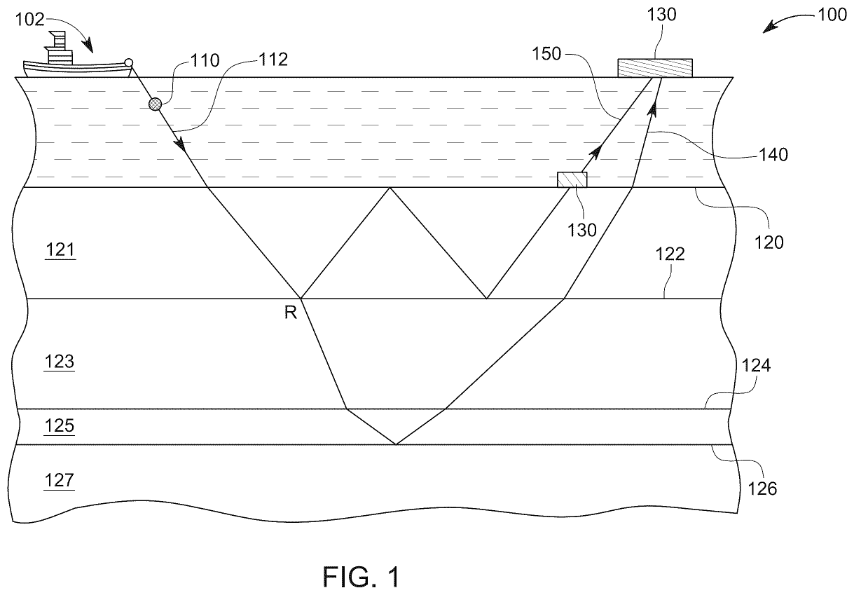

According to an embodiment, a method 300 for estimating the modeled data p at a desired location (for example, at the location of the sensor 130 in FIG. 1) based on a parameter volume that changes as a function of the source-wavefield propagation direction is discussed with regard to FIG. 3. Note that because the source-wavefield propagation direction explicitly changes with a travel-time of the wavefield, the parameter volume implicitly changes with the travel-time of the wavefield. The type of the parameter in this case may be one of:
a. P-velocity (Vp),
b. S-velocity (Vs),
c. Vp/Vs ratio,
d. Density,
e. Anisotropy (e.g., VTI, HTI, TTI, orthorhombic, Vp in vertical and horizontal directions, or perpendicular and parallel to a reflector dip),
f. Absorption (e.g., Qp and/or Qs),
g. P-wave impedance,
h. S-wave impedance,
i. Water saturation,
j. Gas saturation,
k. Hydrocarbon saturation,
l. Clay content,
m. Porosity,
n. Bulk modulus,
o. Shear modulus,
p. Permeability,
q. Pore pressure, or
r. Another parameter type used for wave propagation.

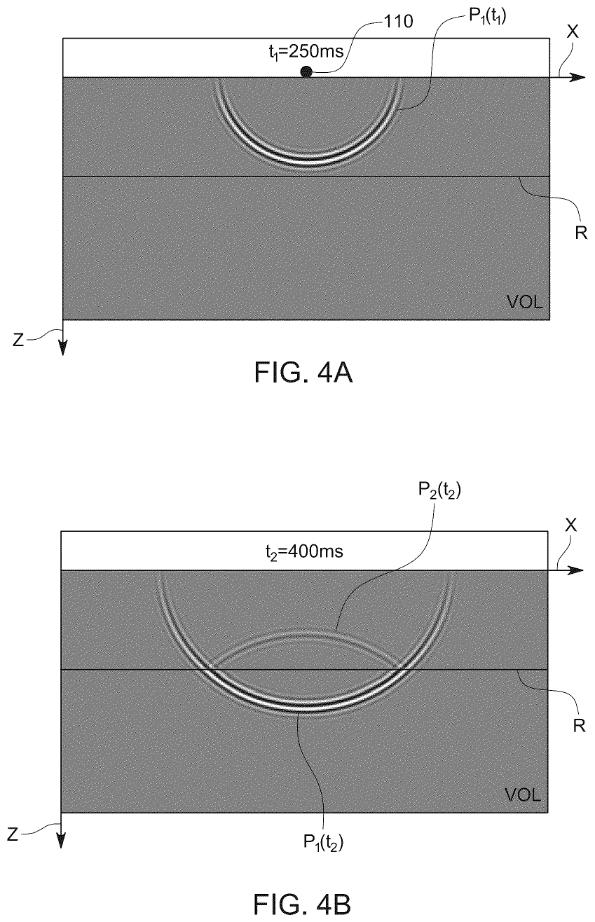

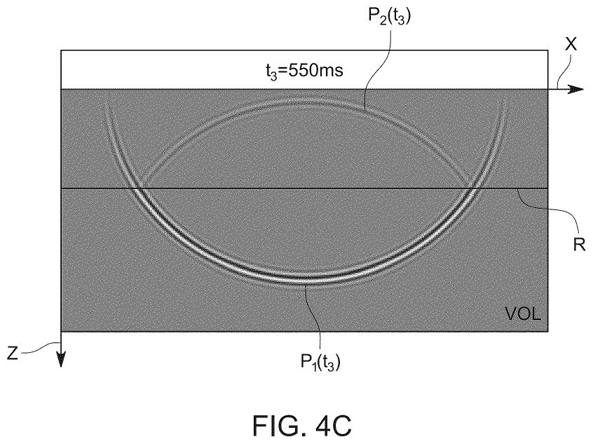

The method 300 may constitute one step in the FWI method 200 of FIG. 2. For example, the method 300 may be one substep in the step 220 of the FWI method of FIG. 2. The method 300 starts in step 302 by receiving a first wavefield P₁, as a function of the subsurface space (x, y, z) corresponding to a first travel-time, within the considered volume, VOL, as illustrated in FIG. 4A. FIG. 4A also shows the seismic source 110 that is responsible for the generation of the first wavefield P₁, a reflector R at which the wavefield will experience a reflection (later in time), and a first time t1 (e.g., 250 ms) at which the first wavefield is received/estimated/calculated. In one application, the first wavefield is calculated based on the characteristics of the source 110, and a wave equation that describes the subsurface below the source 110. Note that the wavefield P₁ (direct arrival) propagates away from the shot location and has spread over a hemisphere within the volume VOL. FIG. 4B shows the first wavefield P₁ at a later time t2 (e.g., 400 ms), further propagated within the volume VOL, and being partially reflected by the reflector R (e.g., located at 600 m depth in the figure). Note that the radius of the direct arrival wavefield P₁ has increased. The resulting wavefield is called the second wavefield P₂ (reflection) in this document. FIG. 4C shows the two wavefields at a later third time t3 (e.g., 550 ms). The radius of the direct arrival wavefield P₁ has further increased. The reflected field P₂ has moved away from the reflector R, toward the surface of the water.

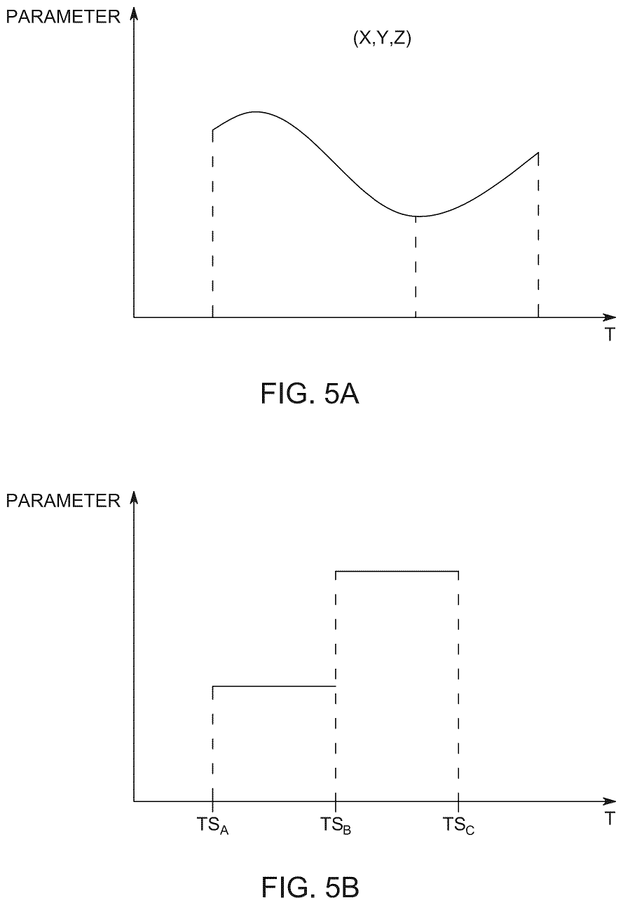

Returning to FIG. 3, the method 300 continues with receiving in step 304 a first parameter volume PV1 describing an earth property as a function of the subsurface space (x, y, z). Example of types of possible parameter volumes have been provided above. Note that the parameter volumes in the method 300 vary as a function of time for the same space location (x, y, z). In other words, as schematically illustrated in FIG. 5A, a given parameter volume (for example, the first parameter volume) has a time dependent value for the same point (x, y, z) in space. For example, the first parameter volume type is related to the density of the point (x, y, z) in the volume VOL. Although the actual density of the point (x, y, z) is typically a constant in time, the corresponding parameter volume PV varies in time in this embodiment. This means that the corresponding parameter volume PV used for the propagation of the various wavefields in the method 300 are not actual physical parameters, but rather they are abstract parameters that are related to the physical parameters through the functionality of the physical parameters. For example, the density of the subsurface at point (x, y, z) is a physical parameter and is used by the wave equation to calculate a wavefield that passes through that point. The parameter volume PV at that point (x, y, z) substitutes the actual density in the used wave equation (i.e., has the same functionality as the actual density) but, differently from the actual density, varies in time for the same physical point. This also means that the parameter volume PV is constant (does not vary in time) during a step of propagating a given wavefield from timestep A (TSA) to timestep B (TSB), based on the wave equation, as illustrated in FIG. 5B. However, after the given wavefield has been propagated from timestep A to timestep B, the parameter volume PV may change from a first value to a second value, which is different from the first value, for a subsequent timestep (a timestep TSc outside the time interval during which the wavefield propagates from timestep A to timestep B, as schematically illustrated in FIG. 5B). Thus, the parameter volume PV is time invariant during one or more propagation steps of one or more wavefields, but may change for successive propagation timesteps, as illustrated in FIG. 5B. In one embodiment, the parameter volume for a given propagation depends on the wavefield. For example, the parameter volume may have a first constant value, between two consecutive timesteps for a first wavefield, and the same parameter value may have a second constant value, between the same two consecutive timesteps, for a second wavefield. The first constant value is different from the second constant value.

This novel idea of making the parameter volume vary in time (as a function of time or as a function of the direction of the wavefield, but not during the propagation operation of a wavefield) makes the results of this method (i.e., the calculation of the modeled data at a desired location) to be of better quality than the existing methods, which results in more accurate images. Note that the existing methods are constrained by the constant value of the density (or any other volume parameter) at a given point in space during calculations between various timesteps while the method of FIG. 3 has the flexibility of making each parameter volume flexible, i.e., the value of the volume parameter may change in time for the same spatial point, over a set of timesteps calculations.

Next, the method estimates (i.e., calculates by applying a propagation method) in step 306 a second wavefield P₂ at point (x, y, z) in space, at a corresponding second travel-time t2, based on the first wavefield P₁ propagating through the first parameter volume PV1. In one application, the second wavefield P₂ is due to a reflection or refraction experienced by the first wavefield P₁ at a reflector R (which may be a physical feature of the earth, for example, a fault). A second parameter volume PV2 is received in step 308, which describes an earth property as a function of the subsurface space (x, y, z). The second parameter volume, similar to the first parameter volume, varies in time for the same point in the volume.

Then, the method estimates in step 310 (e.g., propagates the second wavefield P₂ through the second parameter volume PV2) the third wavefield P₃ as a function of subsurface space (x, y, z) corresponding to the third travel-time t3, based on the second wavefield P₂ propagating through the second parameter volume PV2. In one embodiment, the values in the first parameter volume are different from the values in the second parameter volume.

The third wavefield P₃, which may be calculated at the location of the sensor 130, may then be used in step 240 in FIG. 2 to generate a final image I_{F} of the investigated volume VOL of the subsurface. However, the third wavefield P₃ may be used for other purposes, for example, to update an angle dependent parameter volume that is used to interpret AVA behavior of a reflector in the subsurface. The steps of the method 300 may be implemented on a computing system, which is discussed later.

In one application, the first wavefield P₁, second wavefield P₂, and third wavefield P₃ relate to pressure, particle velocity, particle motion, strain, strain-rate or particle acceleration. The first wavefield, second wavefield, and third wavefield are acoustic or elastic. In another application, the propagations of the wavefields discussed with regard to steps 306 and 310 may be elastic, acoustic, visco-elastic, visco-acoustic, etc. The propagation of the wavefields (schematically illustrated in FIGS. 4A to 4C) may include a reflecting free-surface (not shown) or an absorbing free-surface (not shown). The propagation may be calculated based on a one-way or two-way equation.

In one application, the two or more parameter types of the PV1 and PV2 vary from step 304 to step 308 (e.g., Vp and density). In other words, a different parameter volume type may be used for calculating the propagation of the second wavefield than the parameter volume type for the third wavefield. In one application, the first parameter volume type and the second parameter volume type relate to the same subsurface parameter type. In yet another application, the first parameter volume PV1 has a value at a subsurface position (x1, y1, z1) that is different from the value of the second parameter volume PV2 at the same subsurface position (x1, y1, z1). In one application, the first parameter volume PV1 and the second parameter volume PV2 have the same value at a first location (x1, y1, z1) in the subsurface and have different values at a second location (x2, y2, z2) in the subsurface.

In one embodiment, the first parameter volume PV1 and the second parameter volume PV2 (which are generically called a parameter volume, i.e., the parameter volume includes both the first and second parameter volumes PV1 and PV2) are different in an area to be explored for AVA information and are the same in an area where there is no interest for deriving AVA information.

In one application, the first wavefield, second wavefield, and third wavefield simulate a wavefield following the actuation of a seismic source (source-side wavefield). The first wavefield, second wavefield, and third wavefield may be the result of an areal source injection where data recorded at receiver positions are injected. In one application, the seismic source 110 is actuated within the geographical region corresponding to the first wavefield. The seismic source may be any seismic source type, e.g., airgun, marine vibrator, dynamite, land vibrator, weight drop, etc.

The receivers 130 that detect seismic signals are deployed within the geographical region corresponding to the first (or third) wavefield, e.g., hydrophones, geophones, accelerometers, particle motion sensors, ocean bottom nodes, towed streamers, distributed acoustic sensing (DAS) fiber, etc. In one application, the seismic source and receivers form the seismic acquisition system 100, which may be performed on land, marine, vertical seismic profile (VSP) or transition zone.

The wavefields discussed above with regard to FIG. 3 were assumed to be forward propagated, as illustrated in FIGS. 4A to 4C, i.e., the first travel-time is earlier than the second travel-time, and the second travel-time is earlier than the third travel-time (forward-propagation). However, in one application, it is possible to have reverse propagation, i.e., the first travel-time is later than the second travel-time, and the second travel-time is later than the third travel-time (also called backward-propagation).

The method 300 of FIG. 3 may be adapted to take into consideration the water wave height experienced by the source, when the source is moving up and down in the water due to the ocean waves. For example, the first parameter volume PV1 and the second parameter volume PV2 may vary based on a wave-height variation of a marine air-water interface (free-surface). In this case, the first subsurface parameter type and the second subsurface parameter type may be at least one of density and P-velocity. This approach may be modified so that the wave-height variation is determined based on a receiver ghost timing, where the receiver ghost timing is dependent on a time-shift between a primary receiver arrival and a ghost receiver arrival. In this context, the subsurface is intended to include the water-air free-surface.

The method 300 of FIG. 3 may also be applied to AVA calculations, where an angle dependent parameter volume is used (i.e., the parameter volume is selected to be angle dependent). For this case, the angle dependent parameter volume is received, and the first parameter volume and the second parameter volume are derived from the angle dependent parameter volume. The angle dependent parameter volume defines a subsurface parameter by at least one of:
a. Regular angle positions (e.g., 0, 10, 20, 30, 40, 50 degrees),
b. Irregular angle positions (e.g., 0, 7, 18, 25, 35, 47 degrees),
c. Polynomial expansion, e.g., orthogonal polynomials,
d. Zoeppritz equation (see, Zoeppritz K., 1919, “Erdbebenwellen VIIIB, On the Reflection and Propagation of Seismic Waves”, Gottinger Nachrichten, I, 66-84),
e. Aki and Richards equations (see, Aki and Richards, 2002, “Quantitative Seismology: Theory and Methods”, 2nd edition, University Science Books),
f. Shuey equations (see, Shuey R. T., 1985, “A Simplification of the Zoeppritz Equations”, Geophysics, 50, 609-614), and
g. Fourier transform.

In one embodiment, the angle dependent parameter volume may be variable with the wavefield-propagation azimuth, e.g., the bearing (for example relative to a specific direction, e.g., North) of a wavefield that is propagating. In one application, the wavefield propagation angle volume is received, and the wavefield propagation angle volume is used along with the angle dependent parameter volume to compute the first parameter volume PV1 and/or the second parameter volume PV2.

A wavefield propagation parameter volume may be used by the method 300 of FIG. 3 for various purposes. For example, a first wavefield propagation angle volume describes the direction the first wavefield P₁ is traveling in the subsurface and a second wavefield propagation angle volume describes the direction the second wavefield P₂ is traveling in the subsurface. In one application, the first wavefield propagation angle volume and/or second wavefield propagation angle volume are single-valued or multi-valued. The multi-valued approach describes two propagation angles at the same subsurface position and time-step (i.e., multi-pathing).

The wavefield propagation angle volume may be relative to the x-axis, the y-axis, the z-axis, or a reflector dip. The reflector dip may be constant throughout the volume. In one application, the reflector dip varies in space (x, y, z) at least partially within the subsurface volume. In another application, the reflector dip has a component in more than one direction, e.g., the x-direction and the y-direction.

When the wavefield propagation angle volume is relative to the normal (perpendicular) of a reflector dip, it may be termed as a reflection angle volume. The wavefield propagation angle volume may be a function of the first wavefield and/or the second wavefield. For this computation, the wavefield may be decomposed to estimate a component of the wavefield travelling in a given direction, for example up-going or down-going.

A scattering angle volume is a function of the first wavefield and/or the second wavefield. The reflection angle volume may be dependent on a reflector dip angle volume. In one application, the first parameter volume PV1 is dependent on the wave propagation angle of the first wavefield P₁ and the second parameter volume PV2 is dependent on the wavefield propagation angle of the second wavefield P₂.

In one embodiment, a reflector dip angle volume is dependent on a provisional image I of the subsurface, for example a migration (reverse time migration (RTM), Kirchhoff, etc.) or full-waveform inversion. The wavefield propagation angle volume and/or the reflector dip angle volume are, for example, determined using at least one of:
a. Dip decomposition; e.g., kx-ky-kz or Radon transform,
b. Dip destruction filter,
c. Poynting vector,
d. A spatial derivative; for example following Yang et al or Chemingui et al. discussed above,
e. Ray tracing (beam- or ray-based),
f. Event picking in the space-time domain followed by kinematic migration, and/or
g. Using inference from a convolutional neural network. For example, training a neural network to estimate single/multi-valued propagation angle from a wavefield snapshot and using the network to estimate the propagation angle for the proposed approach.

The provisional image I of the subsurface is used to derive a vector reflectivity volume relating to the reflection coefficient in more than one direction. In some embodiments, the vector reflectivity may be in the range −1 to +1. In one application, the provisional image I of the subsurface is used to derive a reflectivity volume relating to the reflection coefficient in one direction, for example based on a derivative. A reflector dip angle volume (and optionally azimuth) may be derived from the vector reflectivity volume based on trigonometry.

In one embodiment, a difference in the wavefield propagation angle volume computed from the first wavefield P₁ and the wavefield propagation angle volume computed from the second wavefield P₂ is limited to a maximum absolute angle.

As previously discussed, the third wavefield P₃ calculated in step 310 of method 300 may be used for modeling data to be used in the FWI method. In one embodiment, at least one of the first wavefield P₁, second wavefield P₂, and third wavefield P₃ is used (for example further propagated in time and space) to simulate modeled data at receiver (130 in FIG. 1) positions. In one application, the calculated third wavefield may be at the receiver positions and can be extracted by the afore-mentioned extraction operator to provide the modeled data, and no additional wavefields are necessary to be calculated. However, if the third wavefield is not at the receiver positions, then further wavefields are calculated, similar to the third wavefield until reaching the receiver positions. Note that in one embodiment, hundreds if not thousands of wavefields are calculated to reach the receiver positions.

Once the wavefield is calculated at the receiver positions and extracted to provide the modeled data, and the recorded data relating to the receiver positions is received, a misfit function between the recorded data and the modeled data is determined (for example, in step 220 of the method 200 of FIG. 2). The misfit function may be, for example, one of a least-squares, cross-correlation, matching filter, a time-shift, and an optimal transport function. The misfit function may be used to update the angle dependent parameter volume discussed above. In one application, the misfit function is reverse propagated to update at least one of the first parameter volume, the second parameter volume, the angle dependent parameter volume, and an Earth model. Then, the updated parameter volume is used to determine a reflectivity volume, vector reflectivity volume, a reflector dip angle volume, or an Earth model.

In one application, an optimized angle dependent parameter volume is determined based on the misfit function. The optimized angle dependent parameter volume may be used to estimate AVA behavior in the subsurface. The optimized angle dependent parameter volume may also be used to estimate reservoir properties within the subsurface. The optimized angle dependent parameter volume may be corrected for wavelet stretch effects. In one application, the optimized angle dependent parameter volume is used to calculate s-wave velocity in the subsurface. The s-wave velocity in the subsurface may be used as a starting point for elastic FWI.

The afore-mentioned approach may simulate modeled data for receivers within a shot-gather, or, using the reciprocity, for shots within a receiver-gather. The terms shots and receivers may be interchanged based on the reciprocity principle, which is known in the field.

In one application, the third wavefield P₃ calculated in step 310 may be used to update a parameter volume which is used to generate a final image I_{F} of the subsurface. The image I_{F} of the subsurface may relate to an image of the subsurface with a representation of angular-dependent density, or the parameter volume may be used to re-image the subsurface, for example using RTM, Kirchhoff migration, etc.

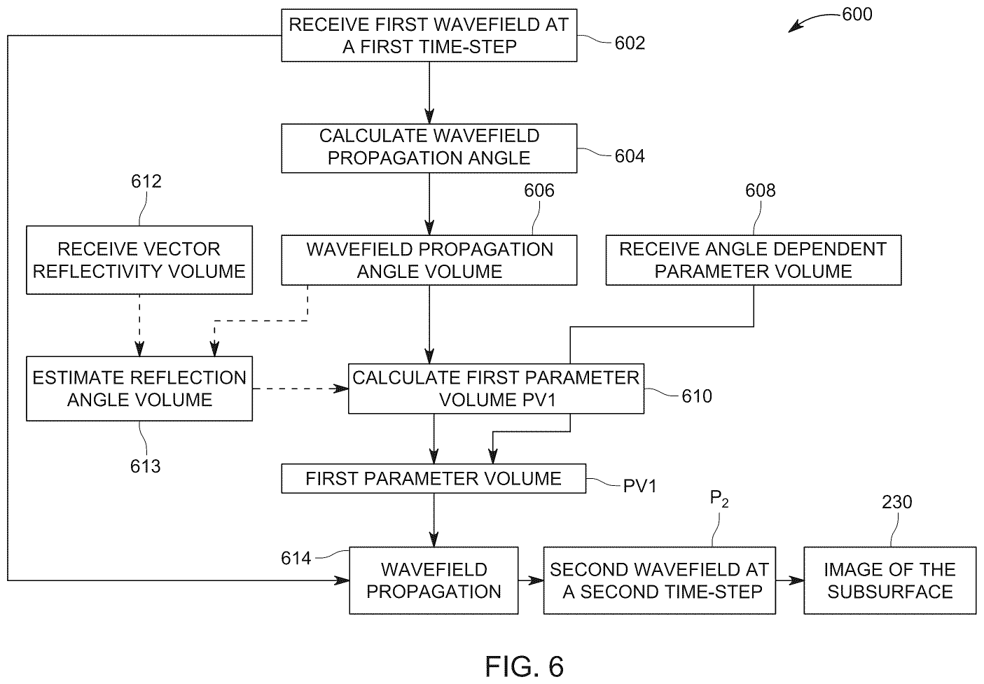

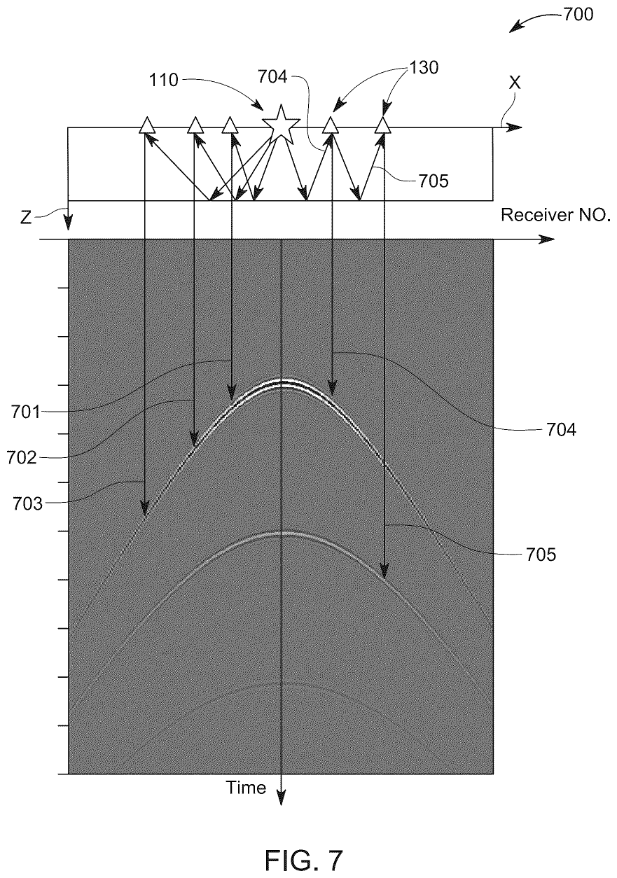

A method 600 for estimating a parameter volume using a wavefield propagation angle volume and an angle dependent parameter volume is now discussed with regard to FIG. 6. The method 600, similar to the method 300, uses a parameter volume that varies with the wavefield propagation angle. In step 602, a first wavefield P₁ is received (similar to step 302) and in step 604 a wavefield propagation angle calculation results in the wavefield propagation angle volume 606. In step 608, an angle dependent parameter volume is received. In step 610, the wavefield propagation angle volume is used along with the angle dependent parameter volume to calculate a first parameter volume PV1. In step 614, the first wavefield P₁ from step 602 and the first parameter volume PV1 from step 610 are used as input to a wavefield propagation method, resulting in a second wavefield P₂ at a second time-step. In step 230 in the method 200 of FIG. 2, the second wavefield P₂ may be used to derive the final image I_{F} of the subsurface, for example the second wavefield may be used to update an angle dependent parameter volume that is used to interpret AVA behavior of a reflector in the subsurface.

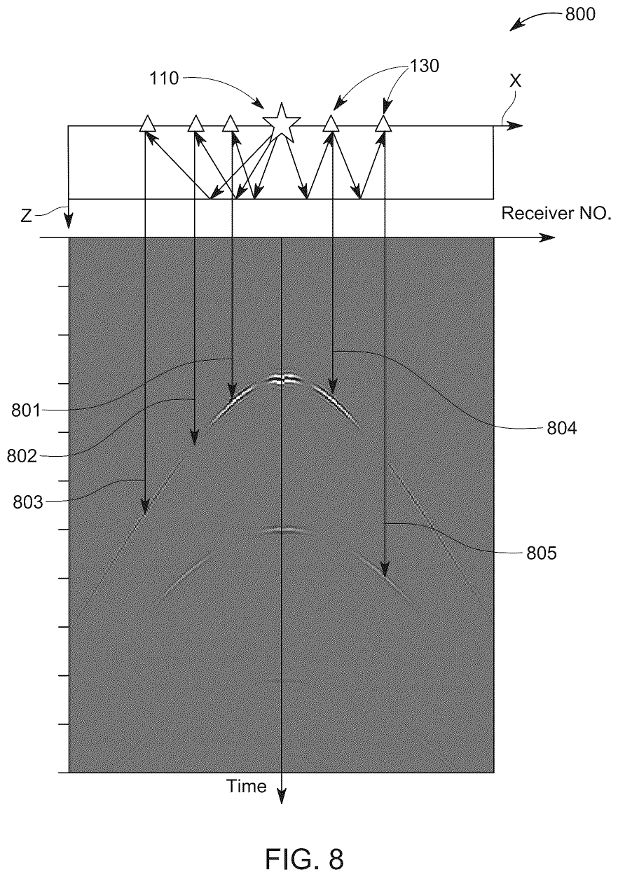

In one embodiment, it is possible to derive an angle dependent density parameter volume to capture the AVA information relating to the received seismic reflection data d. The meaning of AVA information is briefly discussed with regard to FIGS. 7 and 8. FIG. 7 shows synthetic shot-domain data 700 as a function of time and receiver number corresponding to a constant subsurface p-wave velocity of 2000 m/s with a density contrast at 600 m depth. The data relates to an acoustic modelling case where the amplitude of the reflecting wavefield relative to the incident wavefield is constant for all reflection angles. As the source-receiver offset (X axis in the figure) increases, the timing of the primary arrival increases hyperbolically (locations 701, 702, 703). The primary arrival reflects at the free-surface (water-air interface) and generates multiples, for example, the reflection of the primary reflection 704 results in multiple 705.

FIG. 8 shows synthetic shot-domain data 800 also as a function of time and receiver number in a constant-velocity subsurface where the amplitude of the reflecting wavefield relative to the incident wavefield is varying with the reflection angle. In this context, note that the amplitude is positive polarity at receiver zero (apex), negative polarity for locations 801 and 804, almost zero for location 802, and positive polarity at location 803 for the primary and location 805 for the multiple. In this case, the amplitude behavior is somewhat non-physical and it has been designed to illustrate the flexibility of this embodiment.

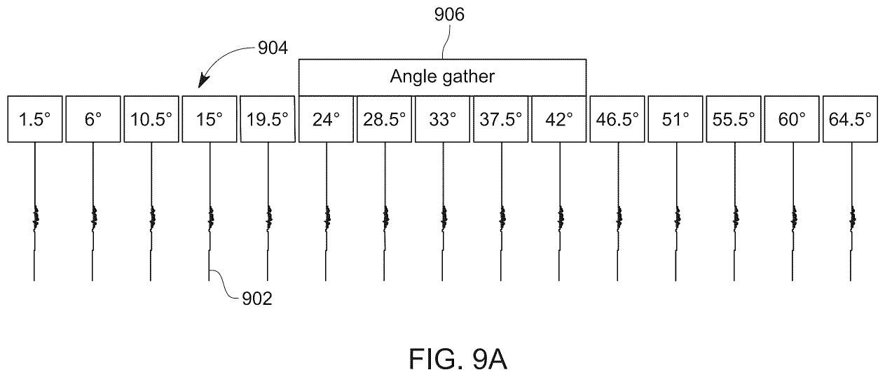

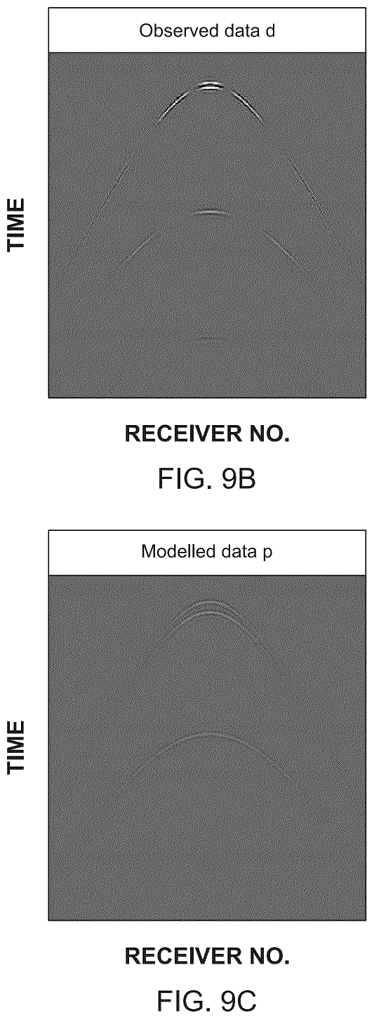

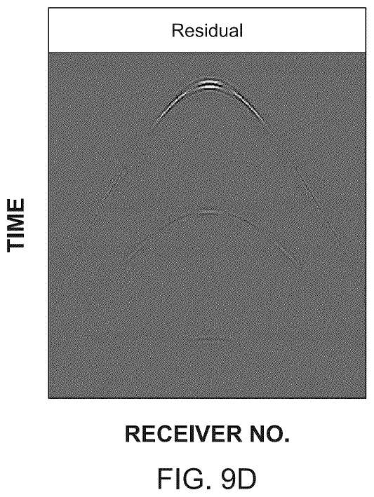

The traditional acoustic FWI method of FIG. 2 may be used to invert for a density model to represent the data in FIG. 8, using the correct velocity of 2000 m/s. The traditional acoustic FWI result is illustrated in FIGS. 9A to 9D. More specifically, FIG. 9A shows plural traces 902 corresponding to various wavefield propagation angles 904. The traces are grouped in angle gathers 906. FIG. 9B illustrates the recorded data d, (which shows the amplitude variation), FIG. 9C shows the modeled data (the amplitude variation is barely visible), and FIG. 9D shows the difference between the data in the FIGS. 9B and 9C, i.e., the residual. As the acoustic modeling used for the traditional FWI method cannot represent the AVA information present in the observed data d, the modeled data does not accurately represent the recorded data, and the residual oscillates in amplitude with a similar pattern to the input data. While it is possible to update the p-wave velocity using the FWI method, this would also not be able to describe this amplitude behavior as a function of the reflection angle.

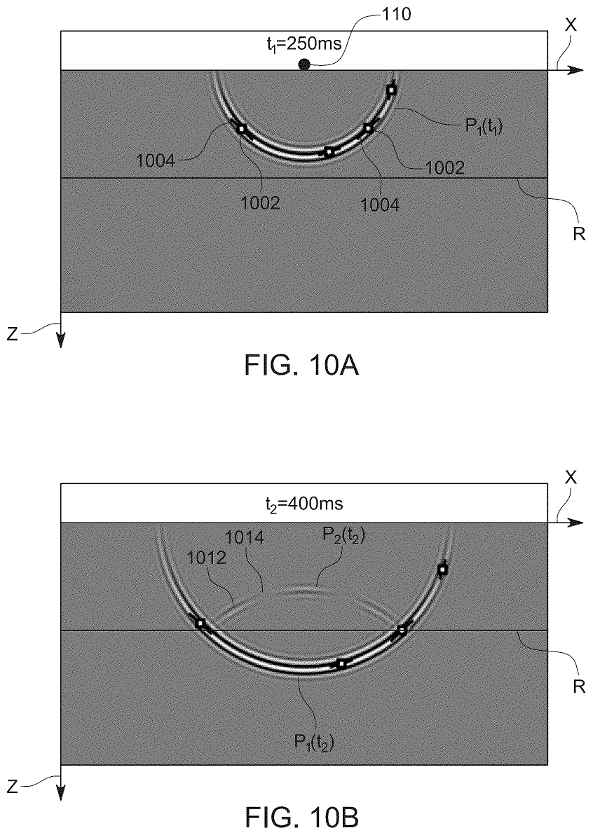

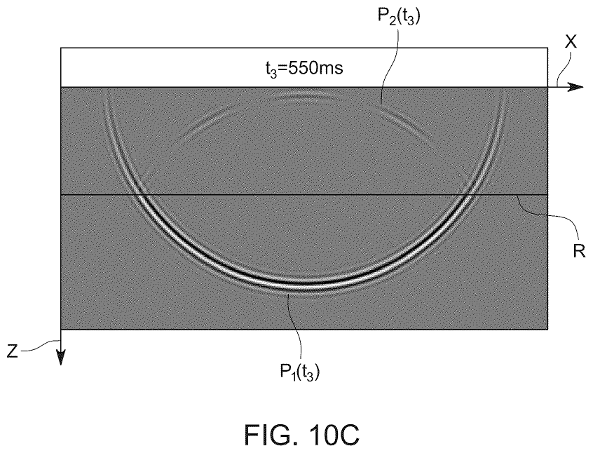

However, the modified FWI method 600, which uses the method 300 for calculating (propagating) the wavefields (as illustrated in FIG. 3), is able to more accurately represent the AVA information. In this regard, FIGS. 10A to 10C illustrate a forward propagation approach for calculating the modeled data p for the method 600. This approach modifies the parameter volume (in this embodiment, the density) such that it varies as a function of the wavefield propagation angle. This means that depending on the wavefield propagation angle at a given time-step in the modelling, a different subsurface density volume is used. As previously discussed, this approach of having an earth parameter varying in time (in spite of the corresponding physical parameter being constant in time), makes the method 600 unique and more accurate than the traditional methods.

A practical AVA application of the method 600 (see FIG. 6) is now discussed with regard to FIGS. 10A to 10C. FIG. 10A shows the first wavefield P₁ received in step 602, where the first wavefield P₁ corresponds to the first travel-time t1=250 ms after the shot actuation. The energy of the shot in FIG. 10A has not yet been reflected, similar to the shot in FIG. 4A, as the wavefield did not reach the reflector R. The method 600 then calculates, in step 604, the wavefield propagation angle (relative to the z-direction) for a position 1002 in the subsurface. The method then calculates in step 606 the wavefield propagation angle volume, i.e., the wavefield propagation angle for each position 1002 in the volume VOL in which the FWI is run. For example, this may be achieved using a dip decomposition (e.g., kx-ky-kz transform), a dip-destruction filter, or a Poynting vector. Several positions 1002 are illustrated in FIG. 10A, and for each position a corresponding tangent 1004 is shown, to the direct arrival relating to the wavefield propagation angle. The angle between a normal to tangent 1004 and the z-direction corresponds to the wavefield propagation angle. Note that plural positions 1002 and corresponding tangents 1004 (and thus corresponding wavefield propagation angles) may be calculated for a given wavefield.

The method then optionally receives in step 612 a vector reflectivity volume R. The vector reflectivity volume R may be defined as a vector having X, Y, and Z components, where each component describes the reflectivity of an image along a corresponding axis of the X, Y, and Z axes. The vector is calculated for each point of the volume VOL considered for the FWI method. In one embodiment, the vector reflectivity volume R is derived from a provisional image I of the subsurface. In this embodiment, the vector reflectivity volume R may be computed by taking the spatial derivative of the provisional image I of the subsurface in the x-, y-, and z-directions. The provisional image I of the subsurface may come, for example, from regular primary migration, multiple migration, full wavefield migration (FWM), or FWI (e.g., density, Vp, Vs, etc.). The vector reflectivity volume R may vary within the subsurface as the geology changes. The vector reflectivity volume R may be used to calculate a reflection dip angle volume, for example using trigonometry. The wavefield propagation angle volume from step 606 is then optionally combined with the reflection angle volume from step 613 to estimate the first parameter volume PV1.

The method then receives in step 608 a first angle-dependent parameter volume (in this case relating to density). Based on the first reflection angle volume from step 608 and optionally the first reflection angle volume from step 613 (if step 613 is not present, the method uses the data from steps 606 and 608), the method calculates in step 610 the first density volume PV1. The angle-dependent first density volume PV1 may relate to a density at different reflection angles, for examples increasing regularly (at 0 degrees, 10 degrees, 20 degrees, etc.). The first density volume may be derived using a linear (or other) weighting of adjacent angle dependent density values. The first density volume is then used to propagate the first wavefield P₁ in step 614, to the next time-step (along with the first wavefield and previous wavefields to describe the wavefield derivative in the time-direction).

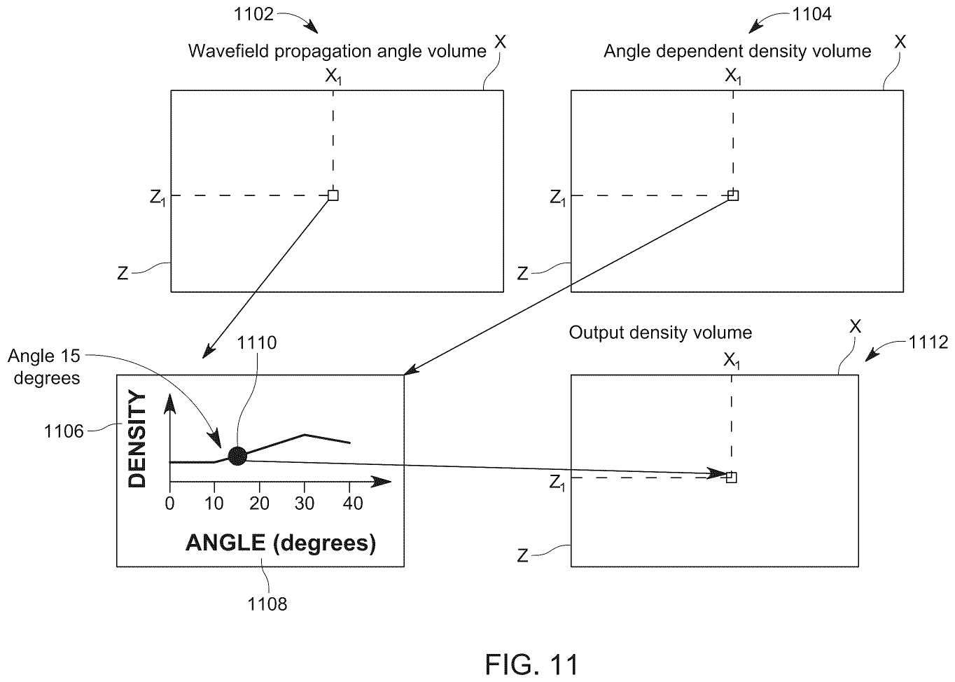

FIG. 11 schematically illustrates the step of deriving a density volume from a wavefield propagation angle volume 1102 (obtained in step 606) and an angle dependent parameter volume 1104 (obtained in step 608). The wavefield propagation angle volume 1102 describes the wavefield propagation angle in the subsurface. For example, as shown in FIG. 11, at example location (x1, z1), the wavefield propagation angle is 15 degrees. The method also receives an angle dependent parameter volume 1104 describing an estimate of the angle-dependent density within the subsurface. At each location, the density 1106 is described at a number of reflection angles 1108 (in this example, every 10 degrees). In this embodiment, the density value 1110 for the position in the subsurface is computed based on a linear weighting of the nearest two density values (for example, at 10 and 20 degrees) in the angle dependent density volume. Reference number 1110 illustrates the interpolated density value which is transferred to the output density volume 1112.

FIG. 10B shows the second wavefield P₂ (calculated in step 614 of FIG. 6) and corresponding to a second travel-time t2=400 ms. The figure shows that in this case, the expanding direct arrival P₁(t2) from the source 110 is qualitatively the same as in FIG. 4B. However, it can be seen that the reflecting wavefield P₂ now has an amplitude variation dependent on the reflection angle (note that there is an opposite polarity amplitude at location 1012 but almost no amplitude at location 1014).

A second reflection angle volume is computed based on the second wavefield P₂, following which a second density volume is derived. This second density volume is used to propagate the wavefield to the third travel-time, resulting in a third wavefield P₃, as illustrated in FIG. 10C. The direct arrival P₁(t3) has now propagated further, as in FIG. 4C, and the reflecting wavefield P₂(t3) has expanded upwards whilst new reflections are encoded with the angle-dependent density volume.

While the travel-times t1=250 ms, t2=400 ms, and t3=550 ms were used in FIGS. 10A to 10C for illustration, normally consecutive timesteps would be more finely sampled, for example in the range 0.1 ms to 10 ms depending on the maximum temporal frequency of interest. The same is true for the travel-times in FIGS. 4A to 4C.

The modelling approach described above may be continued to the maximum required travel-time (which may depend on the configuration of the subsurface), and recordings at the positions of receivers may be extracted to simulate modeled data. The modeled data p may be compared to the observed data d to calculate the misfit function. An inversion process, such as FWI (e.g., step 220 in FIG. 2), may be used to update the angle dependent density volume so as to minimize the misfit function.

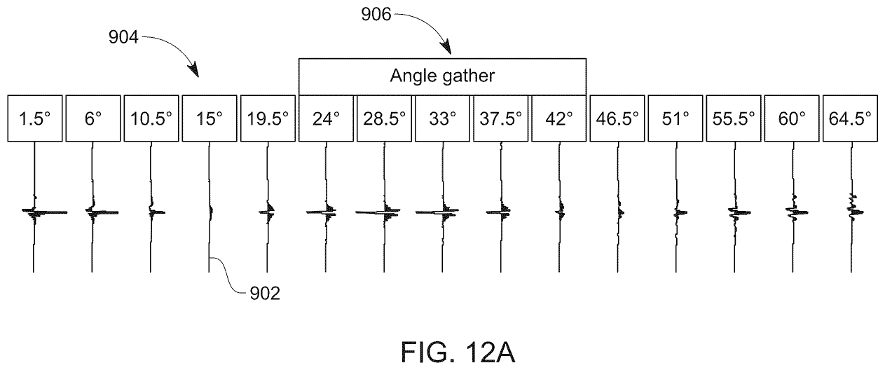

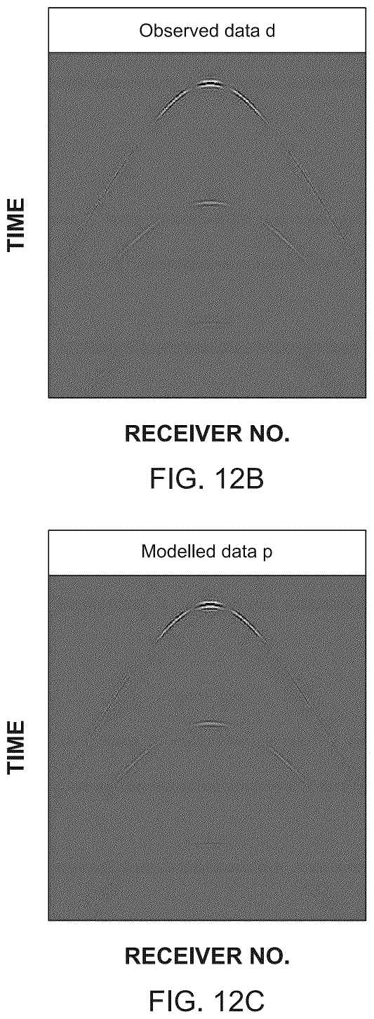

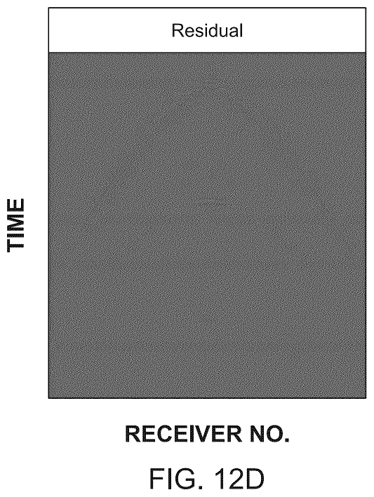

In one embodiment, the result of the proposed angle-dependent density volume method 600 is illustrated in FIGS. 12A to 12D, where elements common to those shown in FIGS. 9A to 9D are labeled with the same reference numbers. Compared to FIGS. 9A to 9D, the angle dependent subsurface density volume results in modeled data p which better matches the observed data d, resulting in a much-reduced residual (see difference between FIG. 9D, where the residual is strongly present, while in FIG. 12D is barely visible, indicating that the modeled data p reproduces the measured data d with high accuracy). The resulting angle-gather, extracted from the angle dependent density volume describes the amplitude variation with reflection angle, i.e., AVA data.

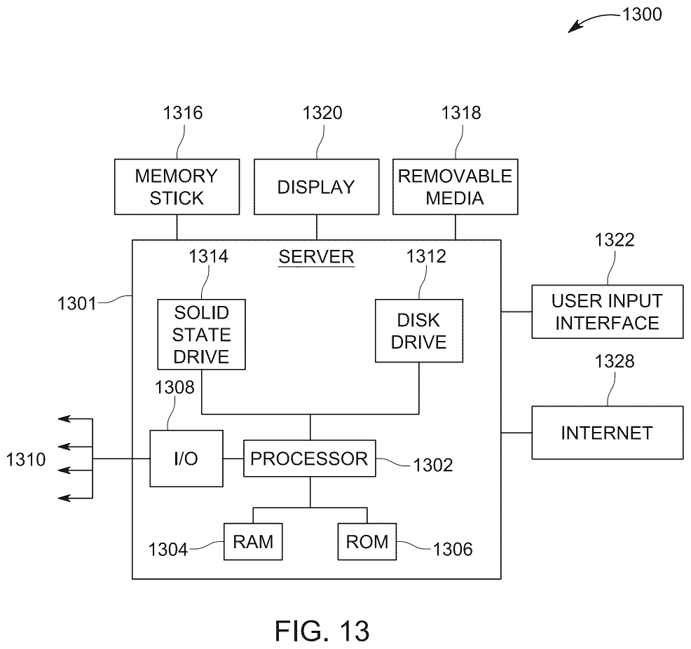

The above-discussed procedures and methods may be implemented in a computing device as illustrated in FIG. 13. Hardware, firmware, software or a combination thereof may be used to perform the various steps and operations described herein. The computing device 1300 is suitable for performing the activities described in the above embodiments and may include a server 1301. Such a server 1301 may include a central processor (CPU) 1302 coupled to a random access memory (RAM) 1304 and to a read-only memory (ROM) 1306. ROM 1306 may also be other types of storage media to store programs, such as programmable ROM (PROM), erasable PROM (EPROM), etc. Processor 1302 may communicate with other internal and external components through input/output (1/O) circuitry 1308 and bussing 1310 to provide control signals and the like. Processor 1302 carries out a variety of functions as are known in the art, as dictated by software and/or firmware instructions.

Server 1301 may also include one or more data storage devices, including hard drives 1312, solid-state drives 1314 and other hardware capable of reading and/or storing information, such as DVD, etc. In one embodiment, software for carrying out the above-discussed steps may be stored and distributed on a memory stick 1316, a solid state storage device 1318 or other form of media capable of portably storing information. These storage media may be inserted into, and read by, devices such as solid state drive 1314, disk drive 1312, etc. Server 1301 may be coupled to a display 1320, which may be any type of known display or presentation screen, such as LCD, plasma display, cathode ray tube (CRT), etc. A user input interface 1322 is provided, including one or more user interface mechanisms such as a mouse, keyboard, microphone, touchpad, touch screen, voice-recognition system, etc.

Server 1301 may be coupled to other devices, control center of a seismic survey. The server may be part of a larger network configuration as in a global area network (GAN) such as the Internet 1328, which allows ultimate connection to various landline and/or mobile computing devices.

As described above, the apparatus 1300 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1302 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1302 may be configured to execute instructions stored in the memory device 1304 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The methods discussed herein may be applied, in addition to the field of subsurface exploration, for example, hydrocarbon exploration and development, to the fields of geothermal exploration and development, and carbon capture and sequestration, or other natural resource exploration and exploitation. They could also be employed for surveying and monitoring for windfarm applications, both onshore and offshore, and also for medical imaging applications.

The term “about” is used in this application to mean a variation of up to 20% of the parameter characterized by this term.

It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a system and method for propagating a wavefield in the subsurface, based on a volume parameter that varies in time. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Bishop, T. N., Bube, K. P., Cutler, R. T., Langan, R. T., Love, P. L., Resnick, J. R., Shuey, R. T, Spindler, D. A., and Wyld, H. W. [1985] Tomographic determination of velocity and depth in laterally varying media, Geophysics, 50 (6), 903-923.
[2] Virieux, J., and Operto, S. [2009] An overview of full-waveform inversion in exploration geophysics: Geophysics, 74, no. 6, WCC1-WCC26.
[3] Poncet, R., J. Messud, M. Bader, G. Lambaré, G. Viguier, and Hidalgo, C. [2018] FWI with Optimal Transport: a 3D Implementation and an application on a Field Dataset. 80th EAGE Conference & Exhibition, Expanded Abstracts, We A12 02.
[4] Warner, M. and Guasch, L. [2014] Adaptive Waveform Inversion—FWI Without Cycle Skipping—Theory. 76th EAGE Conference & Exhibition, Extended Abstracts, We E106 13.
[5] Wang, M., Y. Xie, W. Q. Xu, K. F. Xin, B. L. Chuah, F. C. Loh, T. Manning, and Wolfarth, S. [2016] Dynamic-warping full-waveform inversion to overcome cycle skipping. 86th SEG Annual International Meeting, Expanded Abstracts, 1273-1277.
[6] Cooper, J., Ratcliffe, A. and Poole, G. [2021] Mitigating cycle skipping in full-waveform inversion using partial matching filters. 82nd EAGE Conference & Exhibition, Extended Abstracts, p 1-5.
[7] Zhang, Z., J. Mei, F. Lin, R. Huang, and Wang, P. [2018] Correcting for salt misinterpretation with full-waveform inversion: 88th SEG Annual International Meeting, Expanded Abstracts, 1143-1147.

What is claimed is:

1. A method for generating an image (I_{F}) of a subsurface, the method comprising:
receiving an initial earth model of the subsurface;
receiving a recorded dataset d associated with the subsurface;
generating a modeled dataset p based on the initial earth model and recording positions corresponding to the recorded dataset d, wherein the modeled dataset p is calculated based on a parameter volume PV that varies in time;
updating the initial earth model, to generate an updated earth model, based on a misfit function that depends on the recorded dataset d and the modeled dataset p; and
generating the image I_{F} of the subsurface based on the updated earth model.

2. The method of claim 1, wherein the step of generating a modeled dataset p comprises:
receiving a first wavefield P₁;
receiving a first parameter volume PV1, which is part of the parameter volume PV, wherein the first parameter volume PV1 describes a first earth property as a function of a subsurface space; and
calculating a second wavefield P₂, after the first wavefield P₁ reflects or refracts at a reflector R, based on a propagation of the first wavefield P₁ through the first parameter volume PV1.

3. The method of claim 2, wherein the time corresponds to a propagation of the first or second wavefield, between a source that generates the first wavefield and a receiver that records the recorded dataset d.

4. The method of claim 2, wherein the step of generating a modeled dataset p further comprises:
receiving a second parameter volume PV2, which is part of the parameter volume PV, wherein the second parameter volume PV2 describes a second earth property as a function of the subsurface space; and
calculating a third wavefield P₃, based on a propagation of the second wavefield P₂ through the second parameter volume PV2,
wherein the first parameter volume PV1 and the second parameter volume PV2 are subsets of the parameter volume PV.

5. The method of claim 4, wherein the first and second earth properties are related to a same earth feature or to different earth features.

6. The method of claim 2, wherein the first parameter volume PV1 is dependent on the first wavefield P₁.

7. The method of claim 4, further comprising:
receiving a wavefield propagation angle volume;
receiving an angle dependent parameter volume; and
calculating the first and second parameter volumes based on the wavefield propagation angle volume and an angle dependent parameter volume.

8. The method of claim 7, wherein the angle dependent parameter volume defines a subsurface parameter.

9. The method of claim 2, further comprising:
calculating a reflector dip angle volume based on a provisional image of the subsurface;
calculating a reflection angle volume based on the reflector dip angle volume and the wavefield propagation angle volume;
calculating a parameter volume based on the reflection angle volume.

10. The method of claim 9, when the parameter volume is a density volume, further comprising:
propagating the first and second wavefields based on corresponding density volumes.

11. A method for generating a modeled dataset p associated with a subsurface of the Earth, the method comprising:
receiving a first wavefield P₁;
receiving a first parameter volume PV1, wherein the first parameter volume PV describes an earth property as a function of a subsurface space; and
calculating a second wavefield P₂, after the first wavefield P₁ reflects or refracts at a reflector R in the subsurface, based on a propagation of the first wavefield P₁ through the first parameter volume PV1;
wherein the first parameter volume PV1 varies, after calculating the second wavefield P₂, for a same point in the subsurface space.

12. The method of claim 11, wherein the first parameter volume PV1 is constant with a first value for a first propagation of the first wavefield, is constant with a second value for a second propagation of the second wavefield, and the second value is different from the first value.

13. The method of claim 11, further comprising:
receiving a second parameter volume PV2, wherein the second parameter volume PV2 describes a second earth property as a function of the subsurface space; and
calculating a third wavefield P₃, based on a propagation of the second wavefield P₂ through the second parameter volume PV2.

14. The method of claim 13, wherein the first and second earth properties are related to a same earth feature or related to different earth features.

15. The method of claim 11, wherein the first parameter volume PV1 depends on the first wavefield P₁.

16. The method of claim 13, further comprising:
receiving a wavefield propagation angle volume;
receiving an angle dependent parameter volume; and
calculating the first and second parameter volumes based on the wavefield propagation angle volume and an angle dependent parameter volume,
wherein the angle dependent parameter volume defines a subsurface parameter.

17. The method of claim 16, further comprising:
calculating a reflector dip angle volume based on a provisional image of the subsurface; and
calculating a reflection angle volume based on the reflector dip angle volume and the wavefield propagation angle volume.

18. The method of claim 17, when the first and second parameter volumes are density volumes, further comprising:
propagating the first and second wavefields based on corresponding density volumes.

19. A computing system for generating an image (I_{F}) of a subsurface, the computing system comprising:
an interface configured to receive an initial earth model of the subsurface and also to receive a recorded dataset d associated with the subsurface; and
a processor in communication with the interface and configured to,
generate a modeled dataset p based on the initial earth model and the recorded dataset d, wherein the modeled dataset p is calculated based on a parameter volume PV that varies in time;
update the initial earth model, to generate an updated earth model, based on a misfit function that depends on a difference between the recorded dataset d and the modeled dataset p; and
generate the image I_{F} of the subsurface based on the updated earth model.

20. The computing system of claim 19, wherein the processor is further configured to:
receive a first wavefield P₁;
receive a first parameter volume PV1, which is part of the parameter volume PV, wherein the first parameter volume PV1 describes a first earth property as a function of a subsurface space;
calculate a second wavefield P₂, after the first wavefield P₁ reflects or refracts at a reflector R, based on a propagation of the first wavefield P₁ through the first parameter volume PV1, wherein the first parameter volume PV1 varies for a same point in the subsurface space;
receive a second parameter volume PV2, which is part of the parameter volume PV, wherein the second parameter volume PV2 describes a second earth property as a function of the subsurface space; and
calculate a third wavefield P₃, based on a propagation of the second wavefield P₂ through the second parameter volume PV2.
